(19) United States
(12) Patent Application Publication
(10) Pub. No.: US 2022/0285077 A1
(43) Pub. Date: Sep. 8, 2022

(54) Planar Coil and Planar Transformer

(71) Applicants: Marelli Corporation, Saitama-city, Saitama (JP); National University Corporation Hokkaido University, Sapporo-shi, Hokkaido (JP); Utsunomiya University, Utsunomiya-shi, Tochigi (JP)

(72) Inventors: Satoshi Ogasawara, Sapporo-shi, Hokkaido (JP); Koji Orikawa, Sapporo-shi, Hokkaido (JP); Hirohito Funato, Utsunomiya-shi, Tochigi (JP); Junnosuke Haruna, Utsunomiya-shi, Tochigi (JP); Fumihiro Okazaki, Saitama-city, Saitama (JP)

(21) Appl. No.: 17/632,693

(22) PCT Filed: Jun. 9, 2020
(86) PCT No.: PCT/JP2020/022648

§ 371 Date: Feb. 3, 2022

(30) Foreign Application Priority Data
Aug. 5, 2019 (JP) 2019-143836

(51) Int. Cl. H01F 27/28

(52) U.S. Cl. CPC H01F 27/28

(57) ABSTRACT

Variation in inductance is reduced with a secondary-side coil substrate on which a plurality of wiring layers are superimposedly disposed, and a plurality of coils provided in the secondary-side coil substrate. On the wiring layer, coil patterns corresponding to parts of one circumferences of the coils are formed. On the wiring layer, coil patterns corresponding to remaining parts of the one circumferences of the coils are formed. The coil patterns, and the coil patterns that are provided on the different wiring layers are connected to each other via conduction points in a superimposition direction of the wiring layers, and the one circumferences of the respective coils are formed.

### TECHNICAL FIELD

The present invention relates to a planar type coil and a planar type transformer.

### BACKGROUND

Japanese Patent Laid-Open No. 8-203736 discloses a planar type coil device.

### SUMMARY

In the coil device of Japanese Patent Laid-Open No. 8-203736, a coil pattern is provided on a substrate of an insulator. On a surface of the coil pattern, a plurality of slits extending along a direction in which a current flows are provided to support high frequency circuit drive.

Here, if the coil device disclosed in Japanese Patent Laid-Open No. 8-20373 is used for a center tap type transformer in which secondary-side coils are parallelized, the length of the coil pattern disposed in a loop shape (length of the loop) is different for each coil pattern. This causes variations in inductance of each coil pattern.

Therefore, there is a need to reduce the variation in inductance.

The present invention is: a planar type coil used for a secondary-side coil of a transformer, and includes a substrate on which a plurality of wiring layers are superimposedly disposed, and a plurality of coils provided on the substrate, wherein a coil pattern corresponding to a part of one circumference of the respective coil is respectively formed on each of the wiring layers, the one coil circumference of each of the coils is formed by connecting the coil patterns provided on the different wiring layers to each other via a conduction point in a superimposition direction of the wiring layers, the secondary-side coils are a center tap type coil pair, diodes for rectification and a leader line of a center tap are respectively provided on the one coil circumference of the coil of the respective coils, the center tap is shared between coils in the coil pair, and the respective coil patterns are formed so that lengths to the diodes from the leader line of the center tap are equal lengths in all of the plurality of coils.

Further, the present invention is: a planar type coil used for secondary-side coils of a transformer, and includes a substrate on which a plurality of wiring layers are superimposedly disposed, and a plurality of coils provided on the substrate, wherein on each of the wiring layers, a coil pattern corresponding to a part of one coil circumference of the respective coil is respectively formed, the one coil circumference of each of the coils is formed by connecting the coil patterns provided on the different wiring layers to each other via a conduction point in a superimposition direction of the wiring layers, wherein when a total number of the coils in the substrate is N, a number of the coil patterns formed on one of the wiring layers is N, and the coil patterns are formed by being shifted in phase by (360/N) degrees with a winding line of the coils as a center.

According to the present invention, the variation in inductance can be reduced. Further, due to the layout in which the respective coil patterns disposed on the same plane are not parallel with the other coil patterns that are adjacent to each other, it is possible to reduce loss caused by interference of eddy currents generated in the respective coil patterns.

### BRIEF DESCRIPTION OF THE DRAWINGS

FIG. 1 is a circuit diagram of a DC-DC converter;

FIG. 2 is a schematic view explaining arrangement of a primary-side coil substrate and a secondary-side coil substrate of the DC-DC converter;

FIGS. 3A-3C are views explaining the secondary-side coil substrate;

FIG. 4 is an exploded perspective view of the secondary-side coil substrate;

FIGS. 5A and 5B are views explaining a coil;

FIGS. 6A and 6B are views explaining a coil;

FIGS. 7A and 7B are views explaining a coil pair sharing a center tap;

FIG. 8 is a schematic diagram explaining distances from connection points with center taps in the coil pairs sharing the center taps to diodes;

FIGS. 9A and 9B are views explaining a coil;

FIGS. 10A and 10B are views explaining a coil;

FIGS. 11A and 11B are views explaining a coil pair sharing a center tap;

FIGS. 12A and 12B are plan views of a secondary-side coil substrate seen from a wiring layer side;

FIGS. 13A and 13B are views explaining a secondary-side coil substrate according to a modified example;

FIGS. 14A and 14B are views explaining a coil pattern in the secondary-side coil substrate according to the modified example;

FIGS. 15A-15D are views explaining a secondary-side coil substrate having three wiring layers;

FIGS. 16A-16C are views explaining coil patterns in the respective wiring layers;

FIGS. 17A and 17B are views explaining a secondary-side coil substrate according to a comparative example;

FIGS. 18A and 18B are views explaining a transformer according to a modified example; and

FIGS. 19A-19C are views explaining a secondary-side coil substrate according to a modified example.

### DETAILED DESCRIPTION

Hereinafter, an embodiment of the present invention will be described.

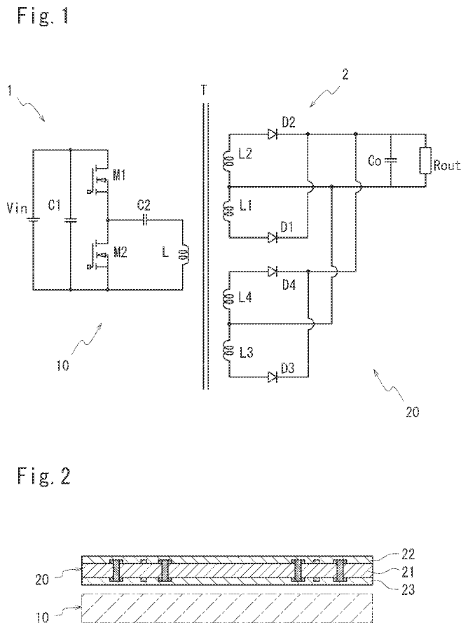

FIG. 1 is a circuit diagram of a DC-DC converter 1.

FIG. 2 is a schematic view explaining arrangement of a primary-side coil substrate 10 and a secondary-side coil substrate 20 of the DC-DC converter 1.

In the DC-DC converter 1, a direct-current voltage Vin inputted to a primary side of a transformer T is converted into an alternating-current voltage by switching of semiconductor devices M1 and M2.

On a secondary side of the transformer T, center tap type coils L1 and L2 and center tap type coils L3 and L4 are provided in parallel.

In the DC-DC converter 1, the alternating-current voltage that is converted from a direct-current voltage on the primary side of the transformer T is transformed between a coil L on the primary side, and the coils L1 and L2 and the coils L3 and L4 on the secondary side.

Subsequently, the transformed alternating-current voltage is returned to a direct-current voltage in the diodes D1 and D2 and the diodes D3 and D4 for rectification, and a smoothing capacitor Co, and is supplied to a load Rout on the secondary side.

In the DC-DC converter 1, a planar type transformer is adopted as the transformer T to turn on/off the semiconductor devices M1 and M2 at high frequencies.

As shown in FIG. 2, the planar type transformer has the primary-side coil substrate 10 having a primary-side coil, and the secondary-side coil substrate 20 having a secondary-side coil (a planar type coil 2).

The primary-side coil substrate 10 is a substrate of a multilayer structure in which a plurality of intermediate layers are disposed between a surface layer and a back surface layer.

Coil patterns are formed on the respective layers (the surface layer, the back surface layer, the intermediate layer) of the substrate, and the coil patterns of the respective layers of the substrate are connected in series to configure the primary-side coil.

The secondary-side coil substrate 20 is a substrate of a multilayer structure in which wiring layers 22 and 23 are disposed on a surface and a back surface of an insulation layer 21.

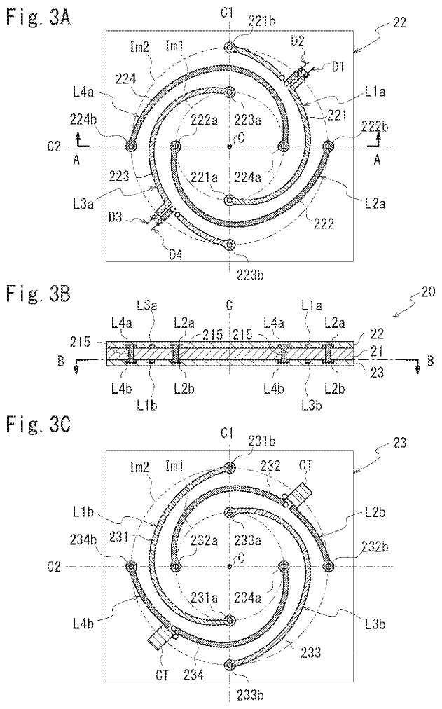

FIGS. 3A-3C are views explaining the secondary-side coil substrate 20. FIG. 3A is a plan view of the secondary-side coil substrate 20 seen from a wiring layer 22 side. FIG. 3B is a sectional view along line A-A in FIG. 3A. FIG. 3C is a sectional view along line B-B in FIG. 3B.

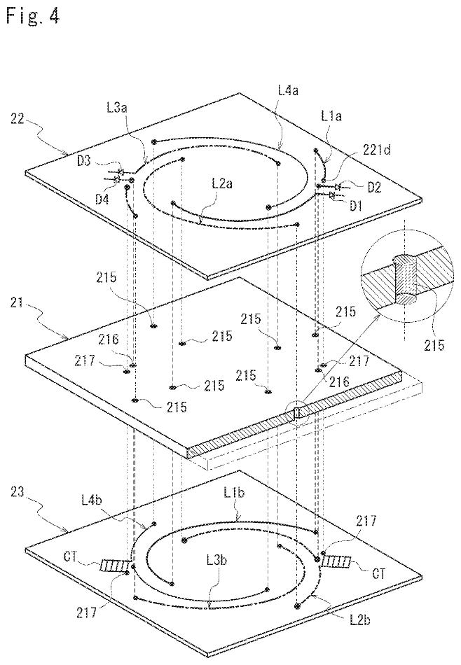

FIG. 4 is an exploded perspective view of the secondary-side coil substrate 20. Note that in FIG. 4, coil patterns L1a to L4a, and L1b to L4b in the wiring layers 22 and 23 are simply indicated.

As in FIG. 1, in the present embodiment, a total of four coils L1 to L4 are formed on the secondary-side coil substrate 20.

As shown in FIG. 3A, the coil patterns L1a to L4a corresponding to part of one circumference of the respective coils L1 to L4 are formed on the wiring layer 22. As shown in FIG. 3B, the coil patterns L1b to L4b corresponding to the remaining part of one circumference of the respective coils L1 to L4 are formed on the wiring layer 23.

As an example, the wiring layers 22 and 23 are formed by covering the coil patterns (L1a to L4a, L1b to L4b) that are formed of a conductive material, with an insulating material.

As shown in FIG. 3B, in the secondary-side coil substrate 20, the coil patterns L1a to L4a that are provided on the wiring layer 22, and the coil patterns L1b to L4b that are provided on the wiring layer 23 are connected to one another via conduction points 215 penetrating the insulation layer 21, and one circumference of each of the respective coils L1 to L4 is formed.

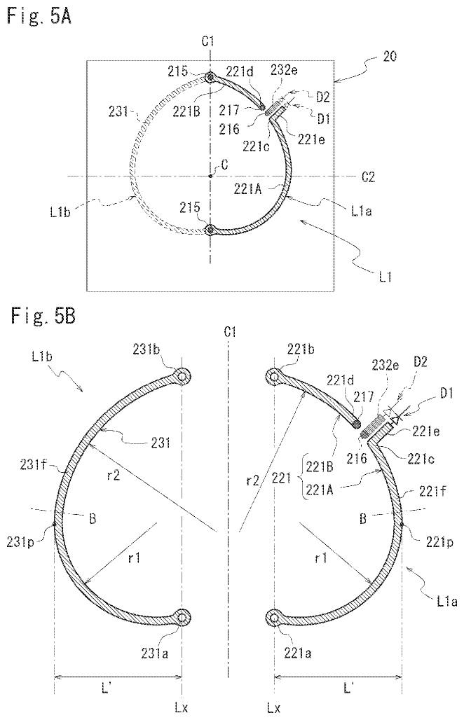

Hereinafter, configurations of the respective coils L1 to L4 will be described. FIGS. 5A and 5B are views explaining the coil L1.

In FIG. 5A is a plan view of the coil L1 seen from a wiring layer 22 side. Note that in FIG. 5A, the coil pattern L1a formed on the wiring layer 22 is shown by a solid line, and the coil pattern L1b formed on the wiring layer 23 is shown by a broken line.

In FIG. 5B is a view explaining the coil pattern L1a and the coil pattern L1b. In FIG. 5B, the coil pattern L1a and the coil pattern L1b are shown in arrangement seen from the wiring layer 22 side of the secondary-side coil substrate 20.

In the secondary-side coil substrate 20, the coil pattern L1a and the coil pattern L1b are disposed with a positional relationship that is symmetrical with an intermediate line C1 therebetween.

The coil L1 is formed by connecting end portions of the coil pattern L1a formed on the wiring layer 22 and the coil pattern L1b formed on the wiring layer 23 to each other with the conduction points 215 and 215 that penetrate the insulation layer 21 in a thickness direction.

As shown in FIG. 5B, the coil pattern L1b has a band-shaped base portion 231. Ring-shaped lands are integrally formed in one end 231a and the other end 231b in a longitudinal direction of the base portion 231.

In the base portion 231, a region 231f forms a curved shape that bypasses an outside in a radial direction of a straight line Lx connecting the one end 231a and the other end 231b. The region 231f is the region between the one end 231a and the other end 231b in the longitudinal direction of the base portion 231.

In the curved region 231f, one end 231a side and the other end 231b side with a boundary line B therebetween are formed with different curvature radiuses r1 and r2.

In an orthogonal direction to the straight line Lx, an outer peripheral point 231p is located in a most separated position from the straight line Lx of the region 231f. The outer peripheral point 231p is separated from the straight line Lx by a predetermined distance L′.

The coil pattern L1a has a band-shaped base portion 221. A basic shape of the band-shaped base portion 221 is substantially the same as a basic shape of the base portion 231 of the coil pattern L1b.

As shown in FIG. 5B, the basic shape of the base portion 221 of the coil pattern L1a is a shape substantially symmetrical with the base portion 231 of the coil pattern L1b with the intermediate line C1 therebetween.

Ring-shaped lands are integrally formed in one end 221a and the other end 221b in a longitudinal direction of the base portion 221.

In the base portion 221, a region 221f forms a curved shape that bypasses an outside in a radial direction of a straight line Lx connecting the one end 221a and the other end 221b.

The region 221f is between the one end 221a and the other end 221b in the longitudinal direction of the base portion 221.

In the curved region 221f, one end 221a side and the other end 221b side with a boundary line B therebetween are formed with different curvature radiuses r1 and r2.

In an orthogonal direction to the straight line Lx, an outer peripheral point 221p is located in a most separated position from the straight line Lx. The outer peripheral point 221p of the region 221f is separated from the straight line Lx by a predetermined distance U.

The base portion 221 of the coil pattern L1a is divided into a base portion 221A on the one end 221a side, and a base portion 221B on the other end 221b side.

The base portion 221A on the one end 221a side has a longer peripheral length than the base portion 221B on the other end 221b side. The base portion 221A has both a portion with the curvature radius r1 and a portion with the curvature radius r2.

An end portion 221c of the base portion 221A and an end portion 221d of the base portion 221B are provided to be spaced from each other.

A connection line 221e with the diode D1 is provided at the end portion 221c of the base portion 221A. The connection line 221e extends rectilinearly in a direction to distance from the straight line Lx from an outer periphery the base portion 221A. Here, outer periphery of the base portion 221A is located in an opposite side with respect to the straight line Lx from among both sides of the base portion 221A. The diode D1 is connected to a tip end of the connection line 221e.

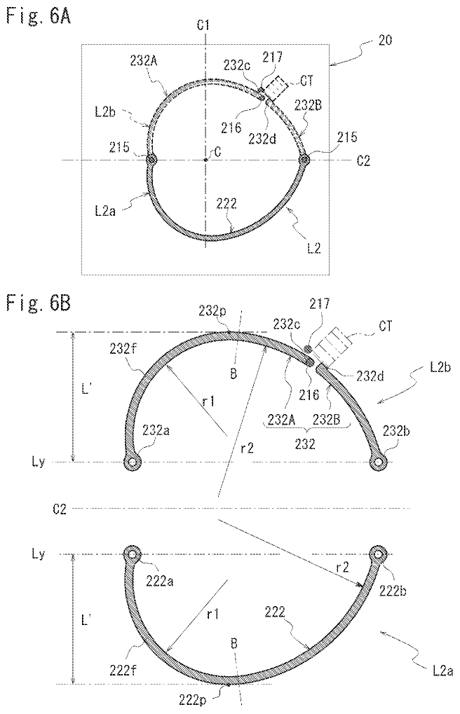

A conduction point 217 penetrating the insulation layer 21 in the thickness direction is connected to the end portion 221d of the base portion 221B. The end portion 221d of the base portion 221B is connected to a center tap CT (see FIGS. 6A and 6B: a leader line of the center tap) on the wiring layer 23 side, via the conduction point 217.

As shown in FIG. 5B, on the wiring layer 22, a connection line 232e with the diode D2 is provided between the end portion 221c of the base portion 221A and the end portion 221d of the base portion 221B.

The connection line 232e is provided parallel to the connection line 221e with the diode D1.

A conduction point 216 that penetrates the insulation layer 21 in the thickness direction is connected to the connection line 232e. The conduction point 216 is located at a region between the end portion 221c of the base portion 221A and the end portion 221d of the base portion 221B.

The connection line 232e is connected to the coil pattern L2b (base portion 232A: see FIGS. 6A and 6B) on the wiring layer 23 side via the conduction point 216.

As shown in FIG. 5A, as seen from the wiring layer 22 side, on the secondary-side coil substrate 20, the coil pattern L1a and the coil pattern L1b are provided in a positional relationship in which the coil patterns L1a and L1b are symmetrical with the intermediate line C1 therebetween.

The coil pattern L1a of the wiring layer 22 and the coil pattern L1b of the wiring layer 23 are disposed so that: the one end 221a of the base portion 221 and one end 231a of the base portion 231 are overlaid on each other; and the other end 221b of the base portion 221 and the other end 231b of the base portion 231 are overlaid on each other.

In the secondary-side coil substrate 20, the one end 221a and the other end 221b of the coil pattern L1a are respectively connected to the one end 231a and the other end 231b of the coil pattern L1b via the conduction points 215 and 215.

A coil pattern corresponding to one circumference of the coil L1 is formed on the secondary-side coil substrate 20, by the coil pattern L1a on the wiring layer 22 side and the coil pattern L1b on the wiring layer 23 side.

Here, one circumference of the coil L1 means a region from the connection line 221e in the coil pattern L1a through the base portion 221A in the coil pattern L1a and the base portion 231 in the coil pattern L1b to the end portion 221d of the base portion 221B in the coil pattern L1a. The end portion 221d is a connecting point to the center tap CT (leader line of the center tap CT).

FIGS. 6A and 6B are views explaining the coil L2.

In FIG. 6A is a plan view of the coil L2 seen from the wiring layer 22 side. Note that in FIG. 6A, the coil pattern L2a formed on the wiring layer 22 is shown by a solid line, and the coil pattern L2b formed on the wiring layer 23 is shown by a broken line.

In FIG. 6B is a view explaining the coil pattern L2a and the coil pattern L2b.

In FIG. 6B, the coil pattern L2a and the coil pattern L2b are shown in arrangement seen from the wiring layer 22 side of the secondary-side coil substrate 20.

In the secondary-side coil substrate 20, the coil pattern L2a and the coil pattern L2b are disposed in a positional relationship in which the coil patterns L2a and L2b are symmetrical with an intermediate line C2 therebetween.

Note that the intermediate line C2 is a straight line orthogonal to the aforementioned intermediate line C1. An intersection point (center line C described later) of the intermediate line C1 and the intermediate line C2 are located in a center of a virtual circle Im1 (see FIGS. 3A-3C).

The coil L2 is formed by connecting end portions of the coil pattern L2a formed on the wiring layer 22 and the coil pattern L2b formed on the wiring layer 23 to each other with the conduction points 215 and 215 that penetrate the insulation layer 21 in the thickness direction.

As shown in FIG. 6B, the coil pattern L2a has a band-shaped base portion 222. In one end 222a and the other end 222b in a longitudinal direction of the base portion 222, ring-shaped lands are integrally formed.

In the base portion 222, a region 222f forms a curved shape that bypasses an outside in a radial direction of a straight line Ly connecting the one end 222a and the other end 222b.

The region 222f is the region between the one end 222a and the other end 222b in the longitudinal direction of the base portion 222. Note that the straight line Ly is orthogonal to the aforementioned straight line Lx.

In the curved region 222f, one end 222a side and the other end 222b side with a boundary line B therebetween are formed with different curvature radiuses r1 and r2.

In an orthogonal direction to the straight line Ly, an outer peripheral point 222p located in a most separated position from the straight line Ly of the region 222f. The outer peripheral point 222p is separated from the straight line Ly by a predetermined distance L′.

The coil pattern L2b has a band-shaped base portion 232. A basic shape of the band-shaped base portion 232 is substantially the same as a basic shape of the base portion 222 of the coil pattern L2a.

As shown in FIG. 6B, the basic shape of the base portion 232 of the coil pattern L2b is a shape substantially symmetrical with the base portion 222 of the coil pattern L2a with the intermediate line C2 therebetween.

Ring-shaped lands are integrally formed in one end 232a and the other end 232b in a longitudinal direction of the base portion 232.

In the base portion 232, a region 232f forms a curved shape that bypasses an outside in a radial direction of a straight line Ly connecting the one end 232a and the other end 232b.

The region 232f is a region between the one end 232a and the other end 232b in the longitudinal direction of the base portion 232.

In the curved region 232f, one end 232a side and the other end 232b side with a boundary line B therebetween are formed with different curvature radiuses r1 and r2.

In an orthogonal direction to the straight line Ly, an outer peripheral point 232p is located in a most separated position from the straight line Lx of the region 232f. The outer peripheral point 232p is separated from the straight line Ly by a predetermined distance L′.

The base portion 232 of the coil pattern L2b is divided into a base portion 232A on the one end 232a side, and a base portion 232B on the other end 232b side.

The base portion 232A has a longer peripheral length than the base portion 232B. The base portion 232A has both a portion with the curvature radius r1 and a portion with the curvature radius r2.

An end portion 232c of the base portion 232A and an end portion 232d of the base portion 232B are provided to be spaced from each other.

A conduction point 216 that penetrates the insulation layer 21 in a thickness direction is connected to the end portion 232c of the base portion 232A. The end portion 232c of the base portion 232A is connected to a connection line 232e to diode D2 (see FIG. 5B) via the conduction point 216.

The center tap CT is connected to the end portion 232d of the base portion 232B. The center tap CT extends rectilinearly in a direction to separate from the straight line Ly from an outer periphery on an opposite side to the straight line Ly.

The conduction point 217 penetrating the insulation layer 21 in the thickness direction is connected to the center tap CT. The center tap CT is connected to the base portion 221B (end portion 221d: see FIG. 5B) of the coil pattern L1a on the coil L1 side via the conduction point 217.

As shown in FIG. 6A, as seen from the wiring layer 22 side, on the secondary-side coil substrate 20, the coil pattern L2a and the coil pattern L2b are provided in a positional relationship in which the coil patterns L2a and L2b are symmetrical with the intermediate line C2 therebetween.

The coil pattern L2a on the wiring layer 22 and the coil pattern L2b on the wiring layer 23 are disposed so that: the one end 222a of the base portion 222 and the one end 232a of the base portion 232 are overlaid on each other; and the other end 222b of the base portion 222 and the other end 232b of the base portion 232 are overlaid on each other.

In the secondary-side coil substrate 20, the one end 222a and the other end 222b of the coil pattern L2a are respectively connected to the one end 232a and the other end 232b of the coil pattern L2b via the conduction points 215 and 215.

A coil pattern corresponding to one circumference of the coil L2 is formed of the coil pattern L2a on the wiring layer 22 side and the coil pattern L2b on the wiring layer 23 side, on the secondary-side coil substrate 20.

Here, the one circumference of the coil L2 means a circumference from the connection line 232e to the diode d2 (see FIGS. 5A and 5B) through the base portion 232A of the coil pattern L2b and the base portion 222 of the coil pattern L2a to the end portion 232d. In the base portion 232B of the coil pattern L2b, the end portion 232d is connected to the center tap CT.

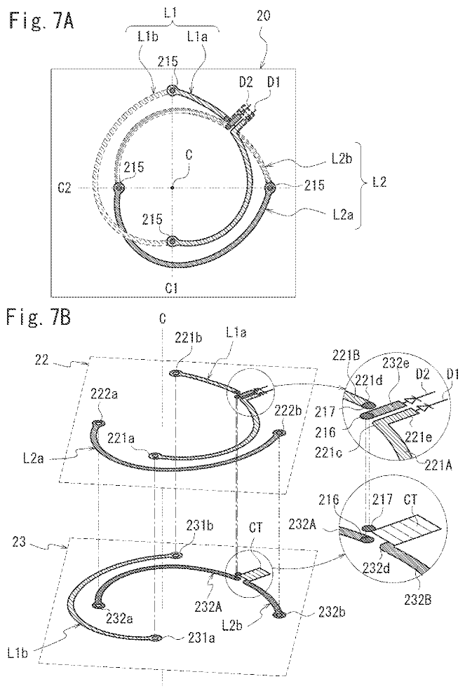

FIGS. 7A and 7B are views explaining a coil pair (coils L1 and L2) sharing the center tap CT.

FIG. 7A is a plane view of the secondary-side coil substrate 20 seen from the wiring layer 22 side. FIG. 7B is a view explaining a connection relationship of the coil L1 and the coil L2. In FIG. 7B, the wiring layer 22 and the wiring layer 23 are shown in separated from each other as an exploded perspective view. Note that in FIG. 7A, only the coils L1 and L2 provided on the secondary-side coil substrate 20 are shown. Further, in FIG. 7B, illustration of the insulation layer 21 is omitted.

As shown in FIG. 7A, in the secondary-side coil substrate 20, the coil L1 and the coil L2 are provided in a positional relationship in which the coils L1 and L2 are shifted in phase from each other by 90 degrees around the center line C.

In the secondary-side coil substrate 20 seen from the wiring layer 22 side, the coil L1 and the coil L2 are provided with intersection regions where the coils L1 and L2 intersect each other.

In FIG. 7A, the intersection regions of the coil L1 and the coil L2 are in a positional relationship in which they are shifted in phase from each other by 180 degrees in a circumferential direction around the center line C. Note that the center line C is a straight line that is orthogonal to the intermediate lines C1 and C2. The center line C penetrates the secondary-side coil substrate 20 in the thickness direction.

Here, as seen from the wiring layer 22 side, in the intersection regions of the coil L1 and the coil L2, the coil L1 and the coil L2 are not electrically connected. This is because the coil patterns L1a and L2a of the coils L1 and L2 are provided on the wiring layer 22, and the coil patterns L1b and L2b of the coils L1 and L2 are provided on the wiring layer 23.

Further, in the intersection regions, the coil L1 and the coil L2 are the closest to each other in the thickness direction (the center line C direction) of the secondary-side coil substrate 20.

In the present embodiment, the diodes D1 and D2 and the center tap CT are provided by using the intersection region where the coil L1 and the coil L2 intersect each other seen from the wiring layer 22 side.

Specifically, the diodes D1 and D2 are provided on the wiring layer 22, and the center tap CT is provided on the other wiring layer 23. The wiring layer 22 is disposed on one side of the insulation layer 21 and the wiring layers 23 is disposed on the other side of the insulation layer 21.

As described above, in the coil L1, the end portion 221d of the coil pattern L1a is connected to the center tap CT via the conduction point 217. In the coil L2, the end portion 232d of the coil pattern L2b is connected to the center tap CT.

In the present embodiment, shapes of the coil patterns L1a and L1b configuring the coil L1 and shapes of the coil patterns L2a and L2b configuring the coil L2 are set so that the following distance 1 and distance 2 become the same.

Distance 1: a distance from the connection point (end portion 221d) with the center tap CT in the coil L1 to the connection line 221e to which the diode D1 is connected.

Distance 2: a distance from the connection point (end portion 232d) with the center tap CT in the coil L2 to the connection line 232e to which the diode D2 is connected.

This is to prevent variations from occurring in inductance between the coil L1 and the coil L2.

In other words, in the coils L1 and L2 that share the center tap CT and that the coil L1 and the coil L2 are connected in series, the center tap CT is connected to a middle point between the connection point with the diode D1 in the coil L1 and the connection point with the diode D2 in the coil L2.

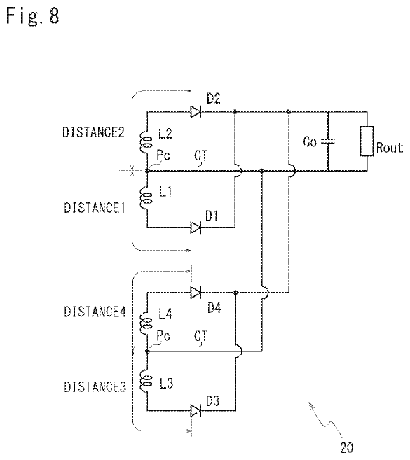

FIG. 8 is a schematic view explaining distances from connection points Pc with the center taps CT to the diodes (diodes D1 to D4), in the coil pairs (the coils L1 and L2, the coils L3 and L4) sharing the center taps.

Here, a relationship between the distance 1 and the distance 2 will be explained by using the schematic view shown in FIG. 8. The shapes of the coils L1 and L2 are set so that the distance 1 and the distance 2 become the same. Here, the distance 1 is a distance from the connection point Pc with the center tap CT in the coil L1 to the diode D1, and the distance 2 is a distance from the connection points Pc with the center tap CT in the coil L2 to the diode D2.

In the present embodiment, the case where the shapes of the coil L1 and the coil L2 seen from the wiring layer 22 side are the same is illustrating (see FIG. 7A). But the shapes of the coils L1 and the coil L2 do not have to be necessarily the same. The shapes of the coil L1 and the coil L2 may be different as long as the distance 1 and the distance 2 are the same.

Note that in the secondary-side coil substrate 20, the coils L3 and L4 are also provided to share the center tap CT.

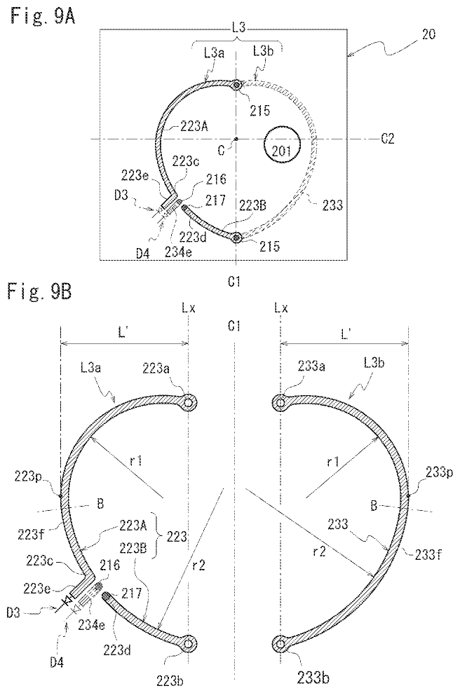

FIGS. 9A and 9B are views explaining the coil L3.

In FIG. 9A is a plan view of the coil L3 seen from the wiring layer 22 side. Note that in FIG. 9A, the coil pattern L3a formed on the wiring layer 22 is shown by a solid line, and the coil pattern L3b formed on the wiring layer 23 is shown by a broken line.

In FIG. 9B is a view explaining the coil pattern L3a and the coil pattern L3b. In FIG. 9B, the coil pattern L3a and the coil pattern L3b are shown in an arrangement seen from the wiring layer 22 side of the secondary-side coil substrate 20.

In the secondary-side coil substrate 20, the coil pattern L3a and the coil pattern L3b are disposed in a positional relationship in which the coil patterns L3a and L3b are symmetrical with the intermediate line C1 therebetween.

The coil L3 is formed by connecting end portions of the coil pattern L3a formed on the wiring layer 22 and the coil pattern L3b formed on the wiring layer 23 to each other with the conduction points 215 and 215 penetrating the insulation layer 21 in the thickness direction.

As shown in FIG. 9B, the coil pattern L3b has a band-shaped base portion 233. Ring-shaped lands are integrally formed in one end 233a and the other end 233b in a longitudinal direction of the base portion 233.

In the base portion 233, a region 233f forms a curved shape that bypasses an outside in a radial direction of a straight line Lx connecting the one end 233a and the other end 233b. The region 233f is a region between the one end 233a and the other end 233b in the longitudinal direction of the base portion 233.

In the curved region 233f, one end 233a side and the other end 233b side with a boundary line B therebetween are formed with different curvature radiuses r1 and r2.

In an orthogonal direction to the straight line Lx, an outer peripheral point 233p located in a most separated position from the straight line Lx of the region 233f. The outer peripheral point 233p is separated from the straight line Lx by a predetermined distance L′.

The coil pattern L3a has a band-shaped base portion 223. A basic shape of the band-shaped base portion 223 is substantially the same as the base portion 233 of the coil pattern L3b.

Ring-shaped lands are integrally formed in one end 223a and the other end 223b in the longitudinal direction of the base portion 223.

In the base portion 223, a region 223f forms a curved shape that bypasses an outside in a radial direction of the straight line Lx connecting the one end 223a and the other end 223b.

The region 223f is a region between the one end 223a and the other end 223b in the longitudinal direction of the base portion 223.

In the curved region 223f, one end 223a side and the other end 223b side with a boundary line B therebetween are formed with different curvature radiuses r1 and r2.

In an orthogonal direction to the straight line Lx, an outer peripheral point 223p is located in a most separated position from the straight line Lx. The outer peripheral point 223p is separated from the straight line Lx by the predetermined distance U.

The base portion 223 of the coil pattern L3a is divided into a base portion 223A on the one end 223a side, and a base portion 223B on the other end 223b side.

The base portion 223A has a longer peripheral length than the base portion 223B. The base portion 223A has both a portion with the curvature radius r1 and a portion with the curvature radius r2.

An end portion 223c of the base portion 223A and an end portion 223d of the base portion 223B are provided to be spaced from each other.

At the end portion 223c of the base portion 223A, a connection line 223e to the diode D3 is provided. The connection line 223e extends rectilinearly in a direction to separate from the straight line Lx from an outer periphery of the base portion 223A. The outer periphery of the base portion 223A is located in an opposite side with respect to the straight line Lx from among both sides of the base portion 223A. The diode D3 is connected to a tip end of the connection line 223e.

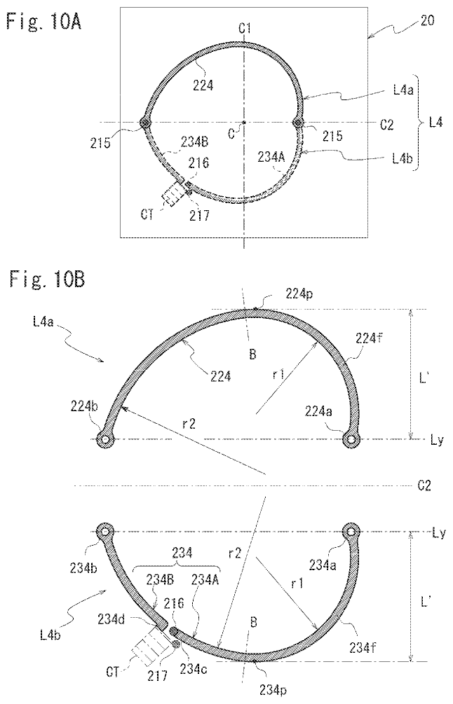

A conduction point 217 penetrating the insulation layer 21 in the thickness direction is connected to the end portion 223d of the base portion 223B. The end portion 223d of the base portion 223B is connected to the center tap CT (see FIGS. 10A and 10B) on the wiring layer 23 side via the conduction point 217.

As shown in FIG. 9A, in the wiring layer 22, a connection line 234e is provided between the end portion 223c of the base portion 223A and the end portion 221d of the base portion 223B.

The connection line 234e is provided parallel to the connection line 223e to the diode D3.

A conduction point 216 that penetrates the insulation layer 21 in the thickness direction is connected to the connection line 234e. the conduction point 216 is located at a region between the end portion 223c of the base portion 223A and the end portion 223d of the base portion 223B.

The connection line 234e is connected to the coil pattern L4b (base portion 234A: see FIGS. 10A and 10B) on the wiring layer 23 side via the conduction point 216.

As shown in FIG. 9A, as seen from the wiring layer 22 side, on the secondary-side coil substrate 20, the coil pattern L3a and the coil pattern L3b are provided in a positional relationship in which the coil patterns L3a and L3b are symmetrical with the intermediate line C1 therebetween.

The coil pattern L3a on the wiring layer 22 and the coil pattern L3b on the wiring layer 23 are disposed so that:

the one end 223a of the base portion 223 and the one end 233a of the base portion 233 are overlaid on each other; and the other ends 223b of the base portion 223 and the other ends 223b of the base portion 233 are overlaid on each other.

In the secondary-side coil substrate 20, the one end 223a and the other end 223b of the coil pattern L3a are respectively connected to the one end 233a and the other end 233b of the coil pattern L3b via the conduction points 215 and 215.

A coil pattern corresponding to one circumference of the coil L3 is formed on the secondary-side coil substrate 20, by the coil pattern L3a on the wiring layer 22 side and the coil pattern L3b on the wiring layer 23 side.

Here, the one circumference of the coil L3 means a region from the connection line 223e in the coil pattern L3a through the base portion 223A of the coil pattern L3a and the base portion 233 of the coil pattern L3b to the end portion 223d of the base portion 223B. The end portion 223d is a connecting point to the center tap CT.

FIGS. 10A and 10B are views explaining the coil L4.

FIG. 10A is a plan view of the coil L4 seen from the wiring layer 22 side. Note that in FIG. 10A, the coil pattern L4a formed on the wiring layer 22 is shown by a solid line, and the coil pattern L4b formed on the wiring layer 23 is shown by a broken line.

FIG. 10B is a view explaining the coil pattern L4a and the coil pattern L4b.

In FIG. 10B, the coil pattern L4a and the coil pattern L4b are shown in an arrangement seen from the wiring layer 22 side of the secondary-side coil substrate 20.

In the secondary-side coil substrate 20, the coil pattern L4a and the coil pattern L4b are disposed in a positional relationship in which the coil patterns L4a and L4b are symmetrical with an intermediate line C2 therebetween.

The coil L4 is formed by connecting end portions of the coil pattern L4a formed on the wiring layer 22 and the coil pattern L4b formed on the wiring layer 23 to each other with the conduction points 215 and 215 that penetrates the insulation layer 21 in the thickness direction.

As shown in FIG. 10B, the coil pattern L4a has a band-shaped base portion 224. Ring-shaped lands are integrally formed in one end 224a and the other end 224b in a longitudinal direction of the base portion 224.

In the base portion 224, a region 224f forms a curved shape that bypasses an outside in a radial direction of a straight line Ly connecting the one end 224a and the other end 224b.

The region 224f is a region between the one end 224a and the other end 224b in the longitudinal direction of the base portion 224.

In the curved region 224f, one end 224a side and the other end 224b side with a boundary line B therebetween are formed with different curvature radiuses r1 and r2.

In an orthogonal direction to the straight line Ly, an outer peripheral point 224p is located in a most separated position from the straight line Ly of the region 224f. The outer peripheral point 224p is separated from the straight line Ly by the predetermined distance L′.

The coil pattern L4b has a band-shaped base portion 234. The band-shaped base portion 234 has a substantially same basic shape as the base portion 223 of the coil pattern L3a.

As shown in FIG. 10B, a basic shape of the base portion 234 of the coil pattern L4b is a shape substantially symmetrical with the base portion 224 of the coil pattern L4a with an intermediate line C2 therebetween.

Ring-shaped lands are integrally formed in one end 234a and the other end 234b in a longitudinal direction of the base portion 234.

In the base portion 234, a region 234f forms a curved shape that bypasses an outside in a radial direction of a straight line Ly connecting the one end 234a and the other end 234b.

The region 234f is a region between the one end 234a and the other end 234b in the longitudinal direction of the base portion 234.

In the curved region 234f, one end 234a side and the other end 234b side with a boundary line B therebetween are formed with different curvature radiuses r1 and r2.

In an orthogonal direction to the straight line Ly, an outer peripheral point 234p located in a most separated position from the straight line Lx of the region 234f. The outer peripheral point 234p is separated from the straight line Ly by the predetermined distance L′.

The base portion 234 of the coil pattern L4b is divided into a base portion 234A on one end 234a side, and a base portion 234B on the other end 234b side.

The base portion 234A has a longer peripheral length than the base portion 234B. The base portion 234A has both a portion with the curvature radius r1 and a portion with the curvature radius r2.

An end portion 234c of the base portion 234A and an end portion 234d of the base portion 234B are provided by being spaced from each other.

The conduction point 216 that penetrates the insulation layer 21 in the thickness direction is connected to the end portion 234c of the base portion 234A. The end portion 234c of the base portion 234A is connected to the connection line 234e to the diode D4 (see FIG. 9B) via the conduction point 216.

The center tap CT is connected to the end portion 234d of the base portion 234B. The center tap CT extends rectilinearly in a direction to separate from the straight line Ly from an outer periphery on an opposite side to the straight line Ly.

The conduction point 217 penetrating the insulation layer 21 in the thickness direction is connected to the center tap CT. The center tap CT is connected to the base portion 223B (end portion 223d: see FIG. 9B) of the coil pattern L3a on the coil L3 side via the conduction point 217.

As shown in FIG. 10A, as seen from the wiring layer 22 side, on the secondary-side coil substrate 20, the coil pattern L4a and the coil pattern L4b are provided in a positional relationship in which the coil patterns L4a and L4b are symmetrical with the intermediate line C2 therebetween.

The coil pattern L4a of the wiring layer 22 and the coil pattern L4b of the wiring layer 23 are disposed so that: the one end 224a of the base portion 224 and the one end 234a of the base portion 234 are overlaid on each other; and the other ends 224b of the base portions 224 and the other end 234b of the base portion 234 are overlaid on each other.

In the secondary-side coil substrate 20, the one end 224a and the other end 224b of the coil pattern L4a are respectively connected to the one end 234a and the other end 234b of the coil pattern L4b via the conduction points 215 and 215.

A coil pattern corresponding to one circumference of the coil L4 is formed on the secondary-side coil substrate 20 by the coil pattern L4a on the wiring layer 22 side and the coil pattern L4b on the wiring layer 23 side.

Here, the one circumference of the coil L4 means a circumference from the connection line 234e to the diode D4 (see FIG. 9) through the base portion 234A of the coil pattern L4b and the base portion 224 of the coil pattern L4a to the end portion 234d. in the base portion 234B of the coil pattern L4b, the end portion 234d is connected to the center tap CT.

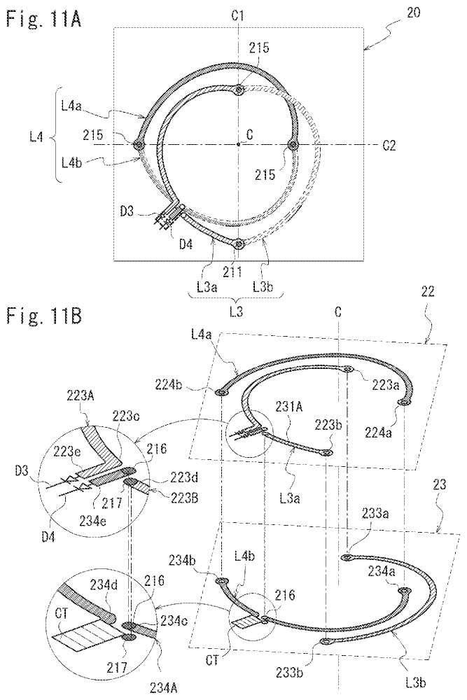

FIGS. 11A and 11B are views explaining the coils L3 and L4 that share the center tap CT.

FIG. 11A is a plan view of the secondary-side coil substrate 20 seen from the wiring layer 22 side. FIG. 11B is a view explaining a connection relationship of the coil L3 and the coil L4. In FIG. 11B, the wiring layer 22 and the wiring layer 23 that are separated from each other are shown as an exploded perspective view. Note that in FIG. 11A, only the coils L3 and L4 that are provided on the secondary-side coil substrate 20 are illustrated. Further, in FIG. 11B, illustration of the insulation layer 21 is omitted.

As shown in FIG. 11A, in the secondary-side coil substrate 20, the coil L3 and the coil L4 are provided in a positional relationship in which the coils L3 and L4 are shifted in phase by 90 degrees around the center line C.

In the secondary-side coil substrate 20 seen from the wiring layer 22, the coil L3 and the coil L4 are provided to have intersection regions where the coils L3 and L4 intersect each other.

In FIG. 11A, the intersection regions of the coil L3 and the coil L4 are in a positional relationship which the coils L3 and L4 are shifted in phase by 180 degrees in the circumferential direction around the center line C.

Here, in the intersection regions of the coil L3 and the coil L4 seen from the wiring layer 22, the coil L3 and the coil L4 are not electrically connected. This is because the coil patterns L3a and L4a of the coils L3 and L4 are provided in the wiring layer 22, and the coil patterns L3b and L4b of the coils L3 and L4 are provided in the wiring layer 23.

Further, in the intersection regions, the coil L3 and the coil L4 are closest to each other in the thickness direction (center line C direction) of the secondary-side coil substrate 20.

In the present embodiment, the diodes D3 and D4 and the center tap CT are provided by using the intersection region where the coil L3 and the coil L4 intersect each other seen from the wiring layer 22 side.

Specifically, the diodes D3 and D4 are provided on the wiring layer 22, and the center tap CT is provided on the other wiring layer 23. The wiring layer 22 is disposed on one side of the insulation layer 21 and the wiring layer 23 is disposed on the other side of the insulation layer 21.

As described above, in the coil L3, the end portion 223d of the coil pattern L3b is connected to the center tap CT via the conduction point 217. In the coil L4, the end portion 234d of the coil pattern L4b is connected to the center tap CT.

Therefore, the coils L3 and L4 are provided to share the center tap CT.

In the present embodiment, the shapes of the coil patterns L3a and L3b configuring the coil L3 and the shapes of the coil patterns L4a and L4b configuring the coil L4 are set so that the following distance 3 and distance 4 become the same.

Distance 3: a distance from the connection point (end portion 223d) with the center tap CT in the coil L3 to the connection line 223e to which the diode D3 is connected.

Distance 4: a distance from the connection point (end portion 234d) with the center tap CT in the coil L4 to the connection line 234e to which the diode D4 is connected

In other words, in the coils L3 and L4 that share the center tap CT and that the coil L3 and the coil L4 are connected in series, the center tap CT is connected to a middle point between the connection point with the diode D3 in the coil L3 and the connection point with the diode D4 in the coil L4.

Here, a relationship between the distances 3 and the distances 4 will be explained by using the schematic diagram shown in FIG. 8. The shapes of the coils L3 and L4 are set so that the distance 3 and the distance 4 become the same. Here, the distance 3 is a distance from the connection point Pc with the center tap CT in the coil L3 to the diode D3, and the distance 4 is a distance from the connection point Pc with the center tap CT in the coil L4 to the diode D4.

In the present embodiment, the case in which the shapes of the coil L3 and coil L4 seen from the wiring layer 22 side are the same is illustrated (see FIG. 11A). But the shapes of the coil L3 and the coil L4 do not have to be necessarily the same. The shapes of the coil L3 and the coil L4 may be different as long as the distance 3 and the distance 4 are the same.

Note that in the present embodiment, the shapes of the coil patterns L1 a to L4a and the coil patterns L1b to L4b of the respective coils L1 to L4 are determined to satisfy the following conditions.

(i) Basic shapes of the respective coils L1 to L4 as seen from the wiring layer 22 side are the same.
(ii) The distance 1, the distance 2, the distance 3 and the distance 4 are the same. The distance 1, the distance 2, the distance 3 and the distance 4 within the respective coils L1 to L4 are respectively the distance from the diodes D1 to D4 to the connection points Pc with the center taps CT.

As described above, the coil pair (the coils L1 and L2), and the coil pair (the coils L3 and L4) that share the center tap CT are provided on the secondary-side coil substrate 20.

In the present embodiment, in order to prevent the four coils L1 to L4 from being electrically connected; the coil patterns L1a to L4a of the coils L1 to L4 are provided on the wiring layer 22 on one side of the insulation layer 21; the coil patterns L1b to L4b of the coils L1 to L4 are provided on the other side of the wiring layer 23; and the insulation layer 21 is between the wiring layers 22 and 23.

As shown in FIG. 3A, on the wiring layer 22, the base portions 221 to 224 of the coil patterns L1a to L4a are provided at intervals of 90 degrees around the center line C.

As described above, the basic shapes in plan view of the base portions 221 to 224 form substantially the same circular-arc shapes. The other ends 221b to 224b in the longitudinal direction of the base portions 221 to 224 are located on a virtual circle Im2. The virtual circle Im2 surrounds the center line C at a predetermined interval.

The base portions 221 to 224 form arc shapes in which distances from the center line C become shorter as approaching from the other ends 221b to 224b to the one ends 221a to 224a.

The one ends 221a to 224a of the base portions 221 to 224 are located on the virtual circle Im1. The virtual circle Im1 surrounds the center line C with predetermined interval and has a smaller outside diameter than the virtual circle Im2.

The one ends 221a to 224a side in the longitudinal direction of the base portions 221 to 224 extend along a circumferential direction around the center line C, on an inside diameter side (center line C side) of the other adjacent coil patterns L1a to L4a.

Thereby, the peripheral lengths of the coil patterns L1a to L4a are ensured while avoiding contact with the other coil patterns L1a to L4a.

The one ends 221a and 223a and the other ends 221b and 223b of the base portions 221 and 223 are located on the same intermediate line C1. The base portions 221 and 223 are provided in the positional relationship in which the base portions 221 and 223 are shifted in phase by 180 degrees in the circumferential direction around the center line C.

The one ends 222a and 224a and the other ends 222b and 224b of the base portions 222 and 224 are located on the same intermediate line C2. The base portions 222 and 224 are provided in a positional relationship in which the base portions 222 and 224 are shifted in phase by 180 degrees in the circumferential direction around the center line C.

As shown in FIG. 3C, on the wiring layer 23, the base portions 231 to 234 of the coil patterns L1b to L4b are provided at intervals of 90 degrees around the center line C.

As described above, the basic shapes in plan view of the base portions 231 to 234 form substantially the same circular-arc shapes. The other ends 231b to 234b in the longitudinal direction of the base portions 231 to 234 are located on the virtual circle Im2. The virtual circle surrounds the center line C at the predetermined interval.

The base portions 231 to 234 form the arc shapes in which the distances from the center line C become shorter as approaching from the other ends 231b to 234b to the one ends 231a to 234a.

The one ends 231a to 234a of the base portions 231 to 234 are located on the virtual circle Im1. The virtual circle Im1 surround the center line C with determined interval and has a smaller outside diameter than the virtual circle Im2.

The one ends 231a to 234a sides in the longitudinal direction of the base portions 231 to 234 extend along the circumferential direction around the center line C, on the inside diameter sides (center line C sides) of the other adjacent coil patterns L1b to L4b.

Thereby, the peripheral lengths of the coil patterns L1b to L4b are ensured while avoiding contact with the other coil patterns L1b to L4b.

The one ends 231a and 233a and the other ends 231b and 233b of the base portions 231 and 233 are located on the same intermediate line C1. The base portions 231 and 233 are provided in the positional relationship in which the base portions 231 and 233 are shifted in phase by 180 degrees in the circumferential direction around the center line C.

The one ends 232a and 234a and the other ends 232b and 234b of the base portions 232 and 234 are located on the same intermediate line C2. The base portions 232 and 234 are provided in the positional relationship in which the base portions 232 and 234 are shifted in phase by 180 degrees in the circumferential direction around the center line C.

When the secondary-side coil substrate 20 is seen from the wiring layer 22 side, the coil patterns L1a and L3a and the coil patterns L1b and L3b are provided in the positional relationship in which the coil patterns L1a and L3a and L1b and L3b are symmetrical with the intermediate line C1 therebetween. Furthermore, the coil patterns L2a and L4a and the coil patterns L2b and L4b are provided in the positional relationship in which the coil patterns L2a and L4a and the coil patterns L2b and L4b are symmetrical with the intermediate line C2 therebetween.

Therefore, when the one ends 221a to 224a and the other ends 221b to 224b of the coil patterns L1a to L4a, and the one ends 231a to 234a and the other ends 231b to 234b of the coil patterns L1b to L4b are respectively connected with the conduction points 215 and 215, the total of the four coils L1 to L4 are formed without being electrically connected to one another.

As seen from the wiring layer 22 side, these four coils L1 to L4 are provided to surround the center line C. A region close to the center line C inside of the coils L1 to L4 is a region in which magnetic lines of a combined magnetic field pass. Here, the region close to the center line C is a region close to the center line C inside from the virtual circle Im1 and has substantially a ring-shape.

Furthermore, the diodes D1 and D2 of the coil pair (L1, L2) and the center tap CT are disposed in the positional relationship in which the diodes D1 and D2 and the center tap CT are overlaid on each other in the thickness direction of the secondary-side coil substrate 20. The diodes D3 and D4 of the coil pair (L3, L4) and the center tap CT are disposed in a positional relationship in which the diodes D3 and D4 and the center tap CT are overlaid on each other in the thickness direction of the secondary-side coil substrate 20.

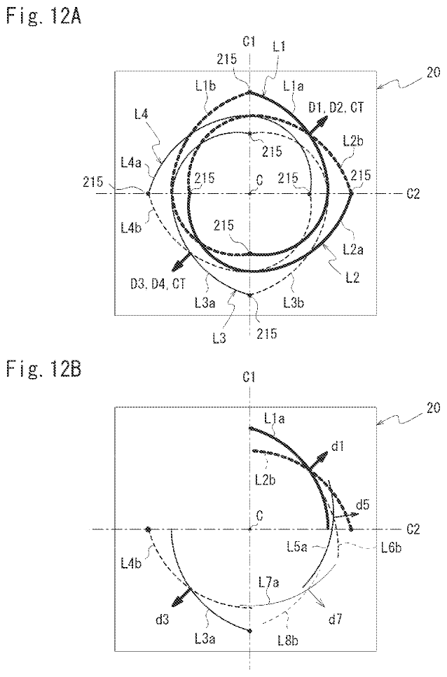

FIGS. 12A and 12B are plan views of the secondary-side coil substrate 20 seen from the wiring layer 22 side.

FIG. 12A is a view showing an arrangement of the coil patterns L1a to L4a and the coil patters L1b to L4b. These coil patterns configure the coils L1 to L4. FIG. 12B is a view explaining a leading direction of the diodes and the center taps. Note that FIG. 12B shows only some of the coil patterns for convenience of explanation.

As shown in FIG. 12A, in the secondary-side coil substrate 20, the coil pair (the coil L1, the coil L2) and the coil pair (the coil L3, the coil L4) are provided by being shifted in phase by 180 degrees around the center line C. The coil pair (the coil L1, the coil L2) shares the center tap CT, and the coil pair (the coil L3, the coil L4) shares the center tap CT.

Therefore, the leading direction of the center tap CT shared by the coils L1 and L2, and the leading direction of the center tap CT shared by the coils L3 and L4 are offset by 180 degrees in the circumferential direction around the center line C. Thus, the center tap CT shared by the coils L1 and L2 and the center tap CT shared by the coils L3 and L4 do not interfere with each other.

Furthermore, the coil patterns are disposed so that the conduction points 215 and 215 of the coil patterns L1a and L1b do not overlap the conduction points 215 and 215 of the coil patterns L2a and L2b seen from a superimposition direction of the wiring layers 22 and 23. Here, one circumference of the coil L1 is formed by coil patterns L1a and L1b, and one circumference of the coil L2 is formed by coil patterns L2a and L2b.

As described above, as seen from the wiring layer 22 side, the diodes D1 and D2 of the coils L1 and L2 are disposed in the position where the diodes D1 and D2 overlap the center tap CT shared by the coils L1 and L2. Furthermore, the diodes D3 and D4 of the coils L3 and L4 are disposed in the position where the diodes D3 and D4 overlap the center tap CT shared by the coils L3 and L4.

Therefore, even when the coil L1 and the coil L2 that share the center tap CT, and the coil L3 and the coil L4 that share the center tap CT are provided on the common secondary-side coil substrate 20, the leading directions of the diodes do not interfere with each other.

Accordingly, it is possible to prevent the leading directions of the center taps of the respective coil pairs from interfering with each other, even when the total number of coil pairs that share the center tap is increased. This is because the interfering of the center tap of respective coil pairs can be prevented by disposing the respective coil pairs with the phase shifted around the center line C.

For example, when the total number of coil pairs is eight, leading directions d1, d3, d5 and d7 of the center taps CT are offset in the circumferential direction around the center line C as shown in FIG. 12B.

Thereby, it is possible to increase the total number of coil pairs that share the center taps without upsizing the secondary-side coil substrate 20.

A benefit of the secondary-side coil substrate 20 according to the present embodiment will be described.

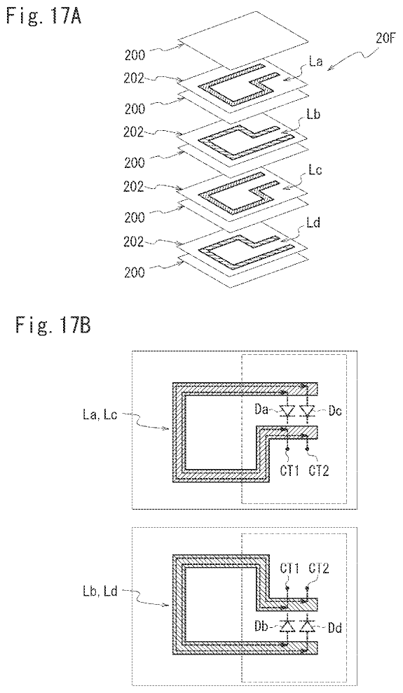

FIGS. 17A and 17B are views explaining a secondary-side coil substrate 20F according to a comparative example. This secondary-side coil substrate 20F has a coil pair (La, Lb) and a coil pair (Lc, Ld), and each coil pair shares a center tap. [0123]

The secondary-side coil substrate 20F shown in FIGS. 17A and 17B is formed by stacking alternately the wiring layer 202 and insulation layers 200. Coil patterns La to Ld having the same shapes are formed on each of the wiring layer 202.

The secondary-side coil substrate 20F includes two coil pairs, one is a coil pair with coil patterns La and Lb and the other is a coil pair with coil patterns Lc and Ld. The coil pair having coil patterns La and Lb share a center tap CT1, and the coil pair having coil patterns Lc and Ld share a center tap CT2.

In the secondary-side coil substrate 20F, the leading directions of diodes and the leading directions of the center tap from each coil pair are the same. Here, each coil paire is the coil pair having coil patterns La and Lb and the coil pair having coil patterns Lc and Ld.

Therefore, depending on arrangement of the substrates on which the diodes Da to Dd are placed, there may be a difference between distances. Here, one is a distance from the center tap CT1 to the diodes Da and Db in the coil pair having coil patterns La and Lb; and the other is a distance from the center tap CT2 to the diodes Dc and Dd in the coil pair having coil patterns Lc and Ld.

In that case, there arises a difference in inductance between the coil pairs.

As described above, in the secondary-side coil substrate 20 according to the present embodiment, the plurality of coils L1 to L4 that are formed in the shapes that the distances from the center taps CT to the diodes D1 to D4 are equal.

For example, if the distances from the center tap CT to the diodes D1 and D2 become different in the coils L1 and L2 that configure the same coil pair, there arises a difference in inductance between the coils L1 and L2.

In this case, the difference in inductance causes the current densities in the coils L1 and L2 become ununiform, and thus influences conduction loss and heat generation in the diodes D1 and D2. It is necessary to allow an excessive margin in considering these influences when selecting a device such as a diode, and this may lead to an increase in cost.

Further, influences due to the difference in inductance be conspicuous as a frequency of turn on/off the semiconductor devices M1 and M2 becomes higher frequency.

As described above, the plurality of coils L1 to L4 that are provided on the secondary-side coil substrate 20 are formed in the shapes in which the distances from the center taps CT to the diodes D1 to D4 are equal. Thereby, problems, such as a problem due to the difference in inductance does not occur.

As described above, the planar type coil 2 used in the secondary-side coil of the transformer T has the following configuration.

(1) The planar type coil 2 has:

the secondary-side coil substrate 20 (substrate) on which a plurality of wiring layers 22 and 23 are superimposedly disposed; and

the plurality of coils L1 to L4 provided on the secondary-side coil substrate 20.

On the wiring layer 22, the coil patterns L1a to L4a are formed. The coil patterns L1a to L4a respectively correspond to parts of one circumferences of the coils L1 to L4.

On the wiring layer 23, the coil patterns L1b to L4b are formed. The coil patterns L1b to L4b respectively corresponds to remaining parts of the one circumferences of the coils L1 to L4.

The coil patterns L1a to L4a are provided on the wiring layers 22. The coil patterns L1b to L4b are provided on the wiring layers 23.

One circumference of each of the coils L1 to L4 is formed by connecting each other the coil patterns L1a to L4a and The coil patterns L1b to L4b.

The coil patterns L1a to L4a and The coil patterns L1b to L4b are connected to each other via the conduction points 215 in the superimposition direction of the wiring layers 22 and 23.

When the substrate having the coils L1 to L4 is prepared by stacking wiring layers on which single coil patterns corresponding to one circumferences of one of the coils L1 to L4 is formed thereon, the length of the coil pattern differs for each of the wiring layers. This arises a difference in inductance between the coils (see FIGS. 17A and 17B).

If the substrate having the coils L1 to L4 is prepared by connecting the coil patterns L1a to L4a and the coil patterns L1b to L4b via the conduction points 215, 215, the lengths of one circumferences of the respective coils L1 to L4 can be made equal. This reduces a difference in inductance between the coils.

Further, coil patterns L1a to L4a are disposed on the same plane in such a layout that the coil patterns are not parallel to the other adjacent coil patterns. The coil patterns L1b to L4b are disposed on the same plane in such a layout that the coil patterns are not parallel to the other adjacent coil patterns. Therefore, it is possible to reduce a loss caused by interference of eddy currents that occur to the respective coil patterns.

(2) The secondary-side coil of the transformer T has the coil pair (coils L1 and L2) of a center tap type.

In the coil pair (coils L1 and L2), the diodes D1 and D2 for rectification and the leader line of the center tap CT that is shared by the other coil are provided. The diodes D1 and D2 and the leader line are provided on the circumferences of the coil patterns L1a and L1b that form one circumference of the coil L1 and the coil patterns L2a and L2b that form one circumference of the coil L2.

The respective coil patterns L1a and L1b and the coil patterns L2a and L2b are formed so that the lengths to the diodes D1 and D2 from the center tap CT become equal lengths in all of the plurality of coils L1 and L2.

According to this configuration, the length from the leader line of the center tap CT to the diode D1 in the coil L1 becomes equal to the length from the leader line of the center tap CT to the diode D2 in the coil L2.

That is, not only when the shapes of coils L1 and L2 are the same, but alto when the shapes of coils L1 and L2 are different, the lengths from the leader line of the center tap CT to each of the diodes D1 and D2 becomes equal. Thereby, the difference in inductance can be reduced.

(3) The transformer T is a transformer having the center tap type coil pair (coils L1 and L2).

In the respective coils L1 and L2, the diodes D1 and D2 for rectification are provided on the circumferences of the coil patterns L1a and L1b that form one circumference of the coil L1 and the coil patterns L2a and L2b that form one circumference of the coil L2.

The leader line of the center tap CT that is shared by the coil L1 and the coil L2 is connected to the point in which the distance from the diode D1 of the coil L1 and the distance from the diode D2 of the coil L2 are the same.

According to this configuration, the length to the diode D1 in the coil L1 and the length to the diode D2 in the coil L2 becomes equal. Thereby the difference in the inductance between the coil L1 and the coil L2 can be reduced.

(4) The coil patterns L1a and L1b and the coil patterns L2a and L2b are formed so that the length of one circumference of the coil L1 formed by connecting the coil patterns L1a and L1b to each other, and the length of the circumference of the coil L2 that is formed by connecting the coil patterns L2a and L2b to each other become the same.

According to this configuration, the difference in the inductance between the coil L1 and the coil L2 can be reduced.

(5) Seen from the superimposition direction of the wiring layers 22 and 23, the coil patterns are disposed so that the conductance points 215 and 215 of the coil patterns L1a and L1b that form one circumference of the coil L1 do not overlap the conduction points 215 and 215 of the coil patterns L2a and L2b that form one circumference of the other coil L2.

The coil patterns L1a and L1b that form one circumference of the coil L1 are provided to avoid electrical connection with the coil patterns L2a and L2b that form one circumference of the other coil L2.

According to this configuration, the coils L1 and L2 are respectively formed electrically independently even when the coil patterns L1a and L1b that form one circumference of the coil L1 are provided in a positional relationship in which the coil patterns L1a and L1b intersect the coil patterns L2a and L2b that form one circumference of the other coil L2, when the secondary-side coil substrate 20 is seen from the superimposition direction of the wiring layers 22 and 23.

Thereby, it is possible to dispose the plurality of coils close to the central region of the secondary-side coil substrate 20 as long as it is possible to provide each coil without interfering the connection points of the coil patterns with the connection points of the coil patterns of other coil.

Thereby, it is possible to make the secondary-side coil substrate 20 compact while reducing the difference in the inductance between the coils.

(6) The total of the four coils L1 to L4 are provided on the secondary-side coil substrate 20 (substrate). The number of the coil patterns L1a to L4a formed on the wiring layer 22 is four, and the number of coil patterns L1b to L4b formed on the wiring layer 23 is four.

In the wiring layers 22 and 23, the coil patterns L1a to L4a, and L1b to L4b are formed every 90 degrees around the winding line (center line C) of the coil.

According to this configuration, it is possible to properly form the coil patterns L1a to L4a and L1b to L4b without bringing the coil patterns in contact with one another.

(7) The secondary-side coil substrate 20 is the substrate on which the wiring layer 22 and the wiring layer 23 are superimposed on each other. The secondary-side coil substrate 20 includes two wiring layers.

As seen from the superimposition direction, each of the coil patterns L1a to L4a that are formed on the wiring layer 22 is formed with half length of the one circumference of each of the coils L1 and L2. Each of the coil patterns L1b to L4b that are formed on the wiring layer 23 is formed with remaining half length of the one circumference of each of the coils L1 and L2.

According to this configuration, it is possible to properly form the one circumference of the coil while suppressing the number of the conduction points 215 that connect the coil patterns L1a to L4a and the coil patterns L1b to L4b to minimum.

(8) As seen from the superimposition direction, the one ends 221a to 224a in the longitudinal direction of the coil patterns L1a to L4a are located on an inside than the other ends 221b to 224b, in the radial direction of the center line C (reference axis). The center line C is orthogonal to the secondary-side coil substrate 20.

The respective coil patterns L1a to L4a formed on the wiring layer 22 are provided by being shifted in phase in the circumferential direction around the center line C.

The respective coil patterns L1b to L4b formed on the wiring layer 23 are provided by being shifted in phase in the circumferential direction around the center line C.

The one ends 221a to 224a sides of the coil patterns L1a to L4a extend along the circumferential direction, on the inside of the other coil patterns L1a to L4a that are adjacent in the circumferential direction around the center line C.

The one ends 231a to 234a sides of the coil patterns L1b to L4b extend along the circumferential direction, on the inside of the other coil patterns L1b to L4b that are adjacent in the circumferential direction around the center line C.

According to this configuration, the plurality of coils are respectively formed electrically independently even when the coil patterns forming one circumference of the coil L1 are provided in the positional relationship in which the coil patterns intersect the coil patterns forming one circumferences of the other coils L2 to L4, when the secondary-side coil substrate 20 is seen from the superimposition direction of the wiring layers 22 and 23.

Further, the coil patterns L1a to L4a that are formed on the same wiring layer 22 (plane) are respectively provided with the basic shapes being the same curved shapes. The coil patterns L1a to L4a are formed in such a manner that the coil patterns L1a to L4a are shifted in phase around the center line C with respect to the other coil patterns L1a to L4a that are adjacent to one another.

Consequently, the respective coil patterns L1a to L4a disposed on the same plane are provided in a layout in which the respective coil patterns L1a to L4a are not parallel to one another. Therefore, it is possible to reduce a loss caused by interference of eddy currents that occur to the respective coil patterns.

The same applies to the coil patterns L1b to L4b formed on the same wiring layer 23 (plane).

### Modified Example 1

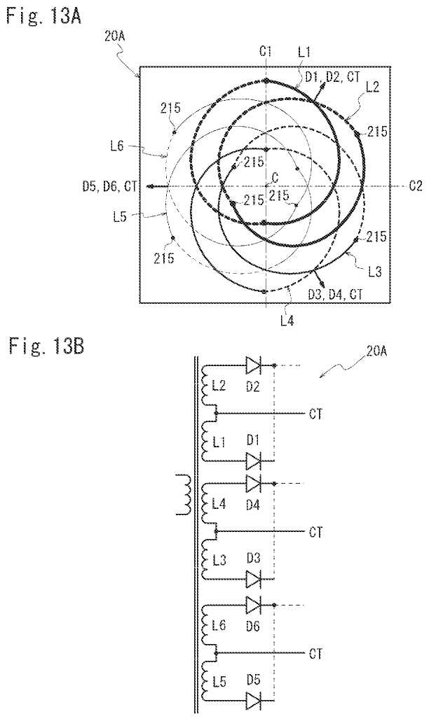

In the aforementioned embodiment, the case in which the two coil pairs sharing the center taps are provided on the secondary-side coil substrate 20 is illustrated. As shown in FIGS. 13A and 13B, a secondary-side coil substrate 20A on which three coil pairs sharing the center taps are provided may be adopted.

FIGS. 13A and 13B are views explaining a secondary-side coil substrate 20A according to a modified example.

FIG. 13A is a plan view of the secondary-side coil substrate 20A according to the modified example seen from a wiring layer 22 side. FIG. 13B is a circuit diagram of the secondary-side coil substrate 20A.

Note that in FIG. 13A, for convenience of explanation, illustration of center taps CT and diodes D1 to D6 is omitted. But, leading directions of center taps CT and diodes D1 to D6 are shown by arrows.

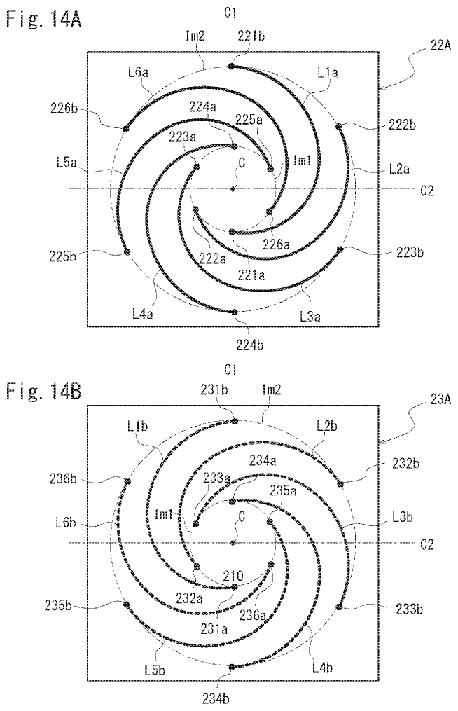

FIGS. 14A and 14B are views explaining coil patterns in the secondary-side coil substrate 20A according to the modified example. FIG. 14A is a view explaining disposition of coil patterns L1a to L6a in a wiring layer 22A. FIG. 14B is a view explaining disposition of coil patterns L1b to L6b in a wiring layer 23A.

As shown in FIG. 13A, in the secondary-side coil substrate 20A, a first coil pair (coils L1 and L2), a second coil pair (coils L3 and L4), and a third coil pair (coils L5 and L6) are provided.

As shown in FIG. 13B, these three coil pairs are provided by being shifted in phase by approximately 120 degrees in a circumferential direction around a center line C.

A leading direction of the center tap CT and the diodes D1 and D2 in the first coil pair (coils L1 and L2) is diagonally upward to the right in FIG. 13A.

A leading direction of the center tap CT and the diodes D3 and D4 in the second coil pair (coils L3 and L4) is diagonally downward to the right in FIG. 13A.

A leading direction of the center tap CT and the diodes D5 and D6 in the third coil pair (coils L5 and L6) is a left direction in FIG. 13A.

These coils L1 to L6 are also formed by being divided into the coil patterns L1a to L6a provided on the wiring layer 22A, and the coil patterns L1b to L6b provided on the wiring layer 23A.

Therefore, the coils L1 to L6 provided in a positional relationship in which the coils L1 to L6 overlap one another as seen from a wiring layer 22A side are independently formed without being electrically connected to one another.

As shown in FIG. 14A, in the wiring layer 22A, one ends 221a to 226a in a longitudinal direction of the coil patterns L1a to L6a are located on a virtual circle Im1. The virtual circle Im1 surrounds the center line C at predetermined intervals.

The coil patterns L1a to L6a form arc shapes in which a separation distance from the center line C becomes larger toward the other ends 221b to 226b sides from the one ends 221a to 226a.

The other ends 221b to 226b of the coil patterns L1a to L6a are located on a virtual circle Im2 that surrounds the center line C at predetermined intervals, and the virtual circle Im2 has a larger outside diameter than the virtual circle Im1.

One ends 221a to 226a sides of the coil patterns L1a to L6b extend along the circumferential direction around the center line C on inside (center line C sides) of the other adjacent coil patterns L1a to L6a.

As shown in FIG. 14B, in the wiring layer 23A, one ends 231a to 236a in a longitudinal direction of the coil patterns L1b to L6b are located on the virtual circle Im1. The virtual circle Im1 surrounds the center line C at the predetermined intervals.

The coil patterns L1b to L6b form arc shapes in which distances from the center line C become larger toward the other ends 231b to 236b sides from the one ends 231a to 236a.

The other ends 231b to 236b of the coil patterns L1b to L6b are located on the virtual circle Im2 that surrounds the center line C at the predetermined intervals. The virtual circle Im2 has the larger outside diameter than the virtual circle Im1.

The one ends 231a to 236a sides of the coil patterns L1b to L6b extend along the circumferential direction around the center line C, on inside (center line C sides) of the other adjacent coil patterns L1b to L6b.

Therefore, a total of the six coils L1 to L6 are formed without being electrically connected to one another, when the coil patterns L1a to L6a and the coil patterns L1b to L6b are connected. Here, coils L1 to L6 are formed by connecting respectively the one ends 221a to 226a and other ends 221b to 226b of the coil patterns L1a to L6a with the one ends 231a to 236a and the other ends 231b to 236b of the coil patterns L1b to L6b (see FIGS. 14A and 14B).

As seen from the wiring layer 22A side, these six coils L1 to L6 are provided to surround the center line C. A region the center line C side of the coils L1 to L6 each having a substantially ring shape is a region in which magnetic lines of a combined magnetic field pass. Here, the region close to the center line C is a region close to the center line C inside from the virtual circle Im1.

The coil patterns L1a to L6a provided on the wiring layer 22A and the coil patterns L1b to L6b provided on the wiring layer 23A are provided so as to be shifted in phase in the circumferential direction around the center line C.

Since the total number of coils in the secondary-side coil substrate 20A is six, numbers of the coil patterns L1a to L6a, and the coil patterns L1b to L6b that are formed on the respective wiring layers 22A and 23A are six.

The coil patterns L1a to L6a, and the coil patterns L1b to L6b are respectively formed so as to be shifted in phase by 60 degrees (=360 degrees/6) around the center line C.

Thereby, contact of the coil patterns L1a to L6a in the wiring layer 22A, and contact of the coil patterns L1b to L6b in the wiring layer 23A are favorably prevented.

The secondary-side coil substrate 20A according to modified example 1 has the following configuration.

(9) When the total number of coils in the secondary-side coil substrate 20A is N, the number of coil patterns that are formed on one wiring layer is N, and the coil patterns are formed so as to be shifted in phase by (360/N) around a winding line of the coils (center line C: a center of the virtual circle Im1).

According to this configuration, the N of coil patterns are formed every (360/N) degrees while being prevented from intersecting one another. Thereby, the required numbers of coil patterns can be properly formed according to the total number of coils.

### Modified Example 2

The aforementioned embodiment illustrates the case in which the coils L1 to L4 are configured by the coil patterns L1a to L4a, and L1b to L4b that are provided on the wiring layers 22 and 23. That is, the coils L1 to L4 are formed by using two wiring layers.

The coils L1 to L4 may be configured by coil patterns L1a to L4a, L1b to L4b and L1c to L4c that are provided on three wiring layers 22B, 23B and 24B.

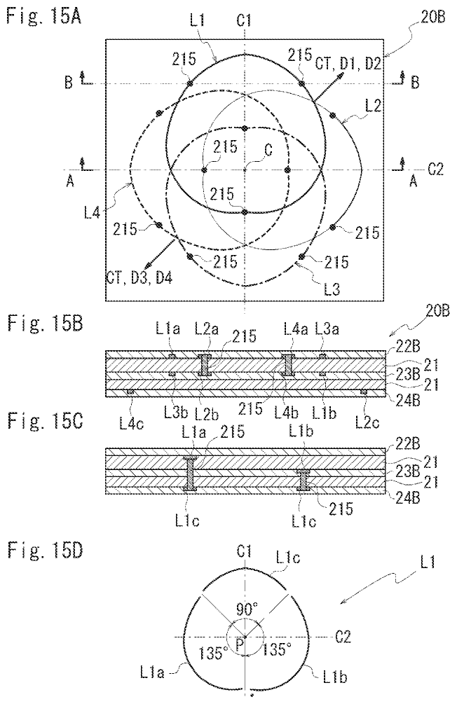

FIGS. 15A-15D are views explaining a secondary-side coil substrate 20B having three wiring layers 22B, 23B and 24B.

FIG. 15A is a plan view of the secondary-side coil substrate 20B seen from a wiring layer 22B side. FIG. 15B is a sectional view taken along line A-A in FIG. 15A. FIG. 15C is a sectional view taken along line B-B in FIG. 15A. FIG. 15D is a view explaining coil patterns L1a to L1c that configure a coil L1 provided in the secondary-side coil substrate 20B.

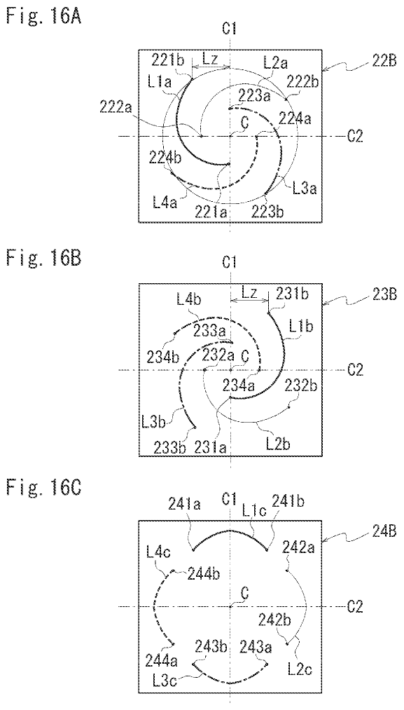

FIG. 16 is a view explaining coil patterns in the respective wiring layers 22B, 23B and 24B.

When the one coil L1 is provided by being divided to the three wiring layers 22B, 23B and 24B, one circumference of the coil L1 is divided into three.

In the modified example, the one circumference of the coil L1 is formed of the coil patterns L1a and L1b in a symmetrical shape with an intermediate line C1 therebetween, and the coil pattern L1c that connects end portions of the coil patterns L1a and L1b (see FIG. 15D).

As shown in FIG. 16A and FIG. 16B, in the coil patterns L1a and L1b, one ends 221a and 231a in a longitudinal direction are located on the intermediate line C1. The other ends 221b and 231b are disposed in positions that are separated by a predetermined distance Lz to an outside in a radial direction, of the intermediate line C1.

In the coil patterns L1a and L1b, regions between the one ends 221a and 231a and the other ends 221b and 231b has curved shapes that bypass the outside in the radial direction, of the intermediate line C1.

The coil pattern L1a and the coil pattern L1b are provided in a positional relationship in which the coil patterns L1a and L1b are symmetrical with the intermediate line C1 therebetween.

One end 241a and the other end 241b of the coil pattern L1c are connected to the other ends 221b and 231b of the coil patterns L1a and L1b. Thereby one circumference of the coil L1 is formed.

The coil pattern L1c forms a shape in which one end 241a side and the other end 241b side are symmetrical with the intermediate line C1 as a boundary (see FIG. 16C).

As shown in FIG. 15D, the coil pattern L1c forms a shape corresponding to a fan end of a fan shape with a point P on the intermediate line C1 as a fan top. The coil pattern L1c has a shape along the fan end of the fan shape, and is provided in an angle range of approximately 90 degrees around the point P.

Therefore, the coil pattern L1a and the coil pattern L1b are provided in angle ranges of approximately 135 degrees around the point P on the intermediate line C1.

In the secondary-side coil substrate 20B, one ends 241a to 244a in the longitudinal direction of the coil patterns L1c, L2c, L3c and L4c of the wiring layer 24B are connected to the other ends 221b, 222b, 223b and 224b of the coil patterns L1a to L4a of the wiring layer 22B via conduction points 215. Conduction points 215 penetrate the insulation layer 21, the wiring layer 23b and the insulation layer 21 (see FIG. 15C).

Further, other ends 241b to 244b in a longitudinal direction of the coil patterns L1c, L2c, L3c and L4c of the wiring layer 24B are connected to other ends 231b, 232b, 233b, and 234b of the coil patterns L1b to L4b of the wiring layer 23B via the conduction points 215 penetrating the insulation layer 21 (FIG. 15B).

In this way, the coils L1 to L4 may be configured by the coil patterns L1a to L4a, L1b to L4b, and L1c to L4c that are provided on the three wiring layers 22B, 23B and 24B.

In this case, distances from the center taps CT to the diodes D1 to D4 in the coils L1 to L4 can be made equal. Thereby, the difference in the inductance between the coils can be reduced.

### Modified Example 3

The aforementioned embodiment illustrates the case in which the planar type transformer has the primary-side coil substrate 10 having the primary-side coil, and the secondary-side coil substrate 20 having the secondary-side coils (planar type coils 2), as shown in FIG. 2.

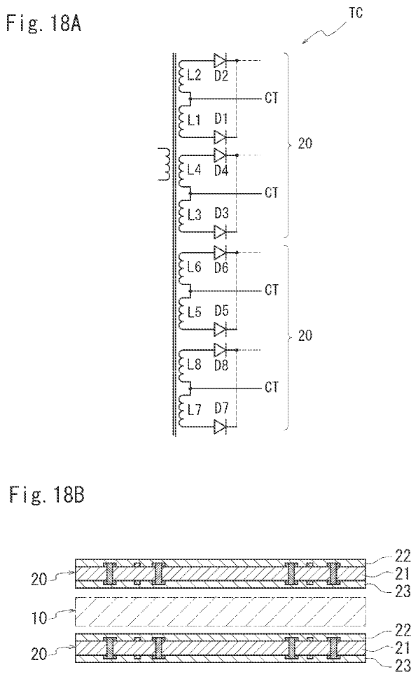

For example, as shown in FIGS. 18A and 18B, a transformer TC (planar type transformer) having a configuration in which a primary-side coil substrate 10 is disposed between secondary-side coil substrates 20 and 20 each having four coils may be adopted.

One of the secondary-side coil substrates 20 has coils L1 to L4, and the other secondary-side coil substrate 20 has coils L5 to L8.

That is, the planar type transformer TC having a following configuration may be adoptable.

(10) The planar type transformer TC has a planar type coils adopted as secondary-side coils. In this planar type transformer TC, a primary-side coil as an input side and two of secondary-side coils are stacked.

The primary-side coil substrate 10 (primary-side coil) is disposed between the secondary-side coil substrates 20 and 20 (secondary-side coils) that are disposed by being spaced in a stacking direction.

According to this configuration, magnetic flux generated on a primary side of the planar type transformer is transmitted to the secondary-side coil substrates 20 from both sides of the primary-side coil substrate 10. Thereby, the planar type transformer TC with high in efficiency as the transformer is given, and thus the reduction in size of the transformer is enabled. [Modified Example 4]

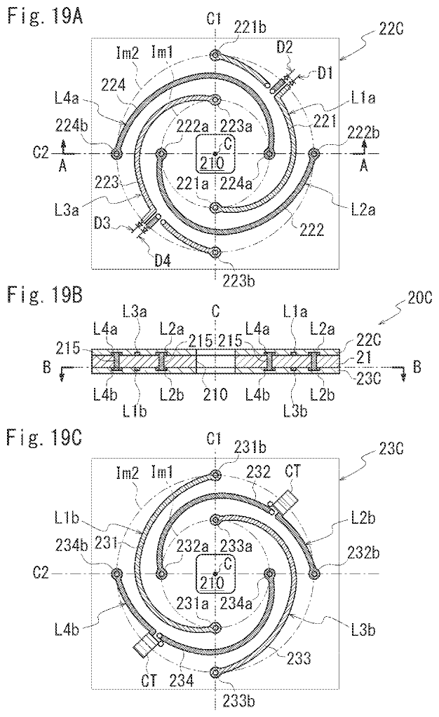

FIGS. 19A-19C are views explaining a secondary-side coil substrate 20C according to a modified example.

FIG. 19A is a plan view of the secondary-side coil substrate 20C seen from a wiring layer 22C side. FIG. 19B is a sectional view taken along line A-A in FIG. 19A. FIG. 19C is a sectional view taken along line B-B in FIG. 19B.

In the aforementioned secondary-side coil substrate 20 (see FIGS. 3A-3C), the coil patterns of the plurality of coils L1 to L4 are provided to surround the center line C as seen from the wiring layer 22 side. Also, the case that the region that is close to the center line C inside of the coils L1 to L4 each forming the substantially ring shape becomes a region where magnetic lines of force pass is illustrated has been exampled.

Such as the secondary-side coil substrate 20C shown in FIG. 19A to FIG. 19C, an insertion hole 210 for installing a ferrite core (not illustrated) may be provided in a region where magnetic lines of force pass.

(11) in the secondary-side coil substrate 20C, coil patterns L1a to L4a that are provided on a wiring layer 22C, and coil patterns L1b to L4b provided on a wiring layer 23C are connected to each other via conduction points 215 in a superimposition direction of the wiring layers 22C and 23C, and thereby one circumference of each of the coils L1 to L4 is formed.

As seen from the wiring layer 22C side, one circumference of each of the coils L1 to L4 is provided in a substantially ring shape that surrounds the insertion hole 210 in which the ferrite core (not illustrated) is installed.

One circumferences of the respective coils L1 to L4 are provided by being shifted in phase in a circumferential direction around the center line C that passes through a center of the insertion hole 210.

By adopting the secondary-side coil substrate 20C of the configuration like this, the coil patterns corresponding to one circumferences of the coils L1 to L4 with the same length can be formed. Thereby, the difference in inductance can be reduced.

### REFERENCE SIGNS LIST

1 DC-DC converter
2 Planar type coil
10 Primary-side coil substrate
20, 20A, 20B, 20C, 20F Secondary-side coil substrate
210 Insertion hole
21 Insulation layer
215, 216, 217 Conduction point
22, 22A, 22B, 22C, 23, 23A, 23B, 23C, 24B Wiring layer
221, 221A, 221B Base portion
221e Connection line
222 Base portion
223, 223A, 223B Base portion
223e Connection line
224 Base portion
231 Base portion
232, 232A, 232B Base portion
233 Base portion
234, 234A, 234B Base portion
234e Connection line
C Center line
C1, C2 Intermediated line
CT Center tap
D1 to D6 Diode
L, L1 to L6 Coil
M1 Semiconductor device
M2 Semiconductor device
T Transformer

1. A planar type coil used for a secondary-side coil of a transformer, comprising:
a substrate on which wiring layers are superimposedly disposed;
secondary-coils on the substrate, wherein a coil pattern corresponding to a part of one coil circumference of a respective secondary-side coil is respectively formed on each of the wiring layers;
the one coil circumference of each of the secondary-side coils is formed across the wiring layers by connecting coil patterns provided on the wiring layers to each other via a conduction point in a superimposition direction of the wiring layers;
the secondary-side coils are a center tap type coil pair;
in the secondary-side coils that configure the coil pair, diodes for rectification and a leader line of a center tap are respectively provided at both end portions of the one coil circumference, the center tap is shared between coils in the coil pair, and
the coil patterns are formed so that lengths to the diodes from the leader line of the center tap are equal lengths in all of the secondary-side coils.

2. The planar type coil according to claim 1, wherein the coil patterns are formed so that lengths of each of the one coil circumference formed by connecting the coil patterns become equal in all of the coils.

3. The planar type coil according to claim 1,
wherein as seen from the superimposition direction of the wiring layers, the coil patterns are disposed so that conduction points of the coil patterns that form the one coil circumference do not overlap conduction points of coil patterns forming another one coil circumference, and
the coil patterns forming the one coil circumference are provided with no connection with the coil patterns forming the other one coil circumference.

4. The planar type coil according to claim 1,
wherein when a total number of the secondary-side coils in the substrate is N,
a number of the coil patterns formed on one of the wiring layers is N, and
the coil patterns are formed by being shifted in phase by (360/N) degrees with a winding line of the secondary-side coils as a center.

5. The planar type coil according to claim 4,
wherein a total number of the secondary-side coils in the substrate is four,
a number of the coil patterns formed on one of the wiring layers is four, and
the coil patterns are formed every 90 degrees with the winding line of the secondary-side coils as the center.

6. The planar type coil according to claim 1,
wherein the substrate is a substrate on which two of the wiring layers are superimposed, and
as seen from the superimposition direction, each of the coil patterns formed on the wiring layers is formed with half a length of the one coil circumference.

7. The planar type coil according to claim 5,
wherein as seen from the superimposition direction, one end in a longitudinal direction of each of the coil patterns are located on an inside than another end, in a radial direction of a reference axis that is orthogonal to the substrate, and
each of the coil patterns formed on the wiring layers is provided by being shifted in phase in a circumferential direction around the reference axis, and one end side of each of the coil patterns extends along the circumferential direction at inside of other coil patterns adjacent in the circumferential direction around the reference axis.

8. A planar type transformer in which the planar type coil according to claim 1 is adopted as a secondary-side coil, and in which a primary-side coil as an input side and two secondary-side coils are stacked,
wherein the primary-side coil is disposed between the secondary-side coils that are disposed by being spaced in a stacking direction of the primary-side coil and the two secondary-side coils.

9. (canceled)

10. (canceled)

11. (canceled)

12. (canceled)

13. (canceled)
